(19) United States
(12) Patent Application Publication
(10) Pub. No.: US 2007/0035647 A1
(43) Pub. Date: Feb. 15, 2007

(54) Imaging device unit and camera system

(75) Inventor: Masafumi Inuiya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/501,812

(22) Filed: Aug. 10, 2006

(30) Foreign Application Priority Data
Aug. 10, 2005 (JP) P2005-232026

(51) Int. Cl. H04N 5/335; H04N 3/14

(52) U.S. Cl. 348/294

(57) ABSTRACT

An imaging device unit to be removably attached to a camera body having an objective lens, the imaging device unit comprises: a board; a solid-state imaging device fixed on the board; a drive circuit that drives the solid-state imaging device; an identification-information generating circuit that generates identification information to specify the solid-state imaging device; and an interface electrically that is connected to the camera body in a state attached to the camera body and supplies identification information to the camera body.

### BACKGROUND OF THE INVENTION

1. Field of the Invention

The present invention relates to a digital-camera system having a solid-state imaging device, and more particularly to an imaging device unit to be easily, removaly attached to a camera body, and to a camera system to removably receive therein such an imaging device unit.

2. Description of the Related Art

There are broadly used digital camera systems having solid-state imaging devices, such as CCD or CMOS sensors.

At present, there is a proposal of a digital camera capable of attaching and changing an imaging device unit having a desired solid-state imaging device to and for its camera body in accordance with user's use purpose, instead of structuring a one-bodied camera by making an imaging device unit having a solid-state imaging device to be removably attached to the camera body mounted with an objective lens and by determining the objective lens suitably for the characteristic of the solid-state imaging device.

In the related-art camera system such as a digital or monitor camera having a solid-state imaging device, there is a possibility to cause shading unless designing a solid-state imaging device with a proper relative position of the imaging device lens and the solid-state imaging device such that the travel distance of the objective lens is equal to the displacement of the microlens for the solid-state imaging device. Meanwhile, in order to prevent color noise, there is a need to design an optical low-pass filter to a characteristic matched to the pixel pitch of the solid-state imaging device. In a camera system the imaging device unit is removably received in the camera body, where the solid-state imaging device provided in the imaging device unit thus received is not adapted in characteristic for the camera body, there encounters a concern over the occurrence of shading or color noise upon taking an image, similarly to the related-art integral-type camera system.

### SUMMARY OF THE INVENTION

The present invention has been made in view of the above circumstances, and it is an object thereof to provide an imaging device unit capable of supplying identification information about the solid-state imaging device to the camera-body side and a camera system having such an imaging device unit, in a camera system having a camera body and an imaging device unit removably received in the camera body.

The foregoing object is to be achieved by an imaging device unit to be removably attached to a camera body having an objective lens, the imaging device unit comprising: a board; a solid-state imaging device fixed on the board; a drive circuit for driving the solid-state imaging device; an

identification-information generating circuit for generating identification information to specify the solid-state imaging device; and an interface electrically connected to the camera body in a state attached to the camera body and for supplying identification information to the camera body.

When the imaging unit is changed for the camera body, the imaging device unit in the invention outputs identification information toward the camera body through the interface. The camera body determines the type of the imaging unit from the identification information, sets parameters for the signal processing circuit at respective values suited for the imaging device unit, and reads out image data after opening and closure of the shutter. This allows the camera body to perform the optimal image processing, storage and display while avoiding from the occurrence of shading and color noise, owing to proper positioning of the imaging device lens relative to the imaging device lens.

It is preferable that, in the imaging device unit, an imaging-timing signal, inputted from the camera body, is outputted to the drive circuit through the interface.

In the imaging device unit according to the invention, after dark current is swept out of the solid-state imaging device prior to image taking by the imaging-timing signal and the solid-state imaging device is placed in a state for taking an image, shutter is to be enabled to open and close.

It is preferable that, in the imaging device unit, image information taken by the imaging device is outputted toward the camera body through the interface.

In the imaging device unit according to the invention, the image information, outputted from the solid-state image through the interface, can be processed on the camera-body side where it is stored to the image memory and displayed on the display on the camera-body side.

It is preferable that, in the imaging device unit, a clock signal, inputted from the camera body, is outputted to the drive circuit through the interface.

In the imaging device unit according to the invention, image signals can be read out of the solid-state image based on the transfer pulse outputted by the drive circuit according to the clock signal.

It is preferable that, in the imaging device unit, there is included a power-source circuit that receives power from a power source provided in the camera body and supplies power to the drive circuit.

In the imaging device unit according to the invention, by stably receiving the power required by the imaging device unit from the power-source circuit on the camera-body side, it is possible to avoid from setting up a battery or the like on the imaging device-unit side and hence to realize the size reduction of the imaging device unit.

The camera system is to be achieved by comprising the above-mentioned imaging device unit and the camera body.

In the camera system according to the invention, the imaging device unit can be changed in accordance with use purpose instead of selecting an objective lens matched to the characteristic of the solid-state imaging device. After the imaging device is placed in an image-taking state by sweeping away the dark current prior to image taking depending upon the recognition of imaging device-unit-based identification information, shutter opening and closing and the subsequent image reading can be implemented. Meanwhile, owing to proper positioning of the imaging device unit relative to the objective lens, shading and color noise can be prevented from occurring.

It is preferable that, in the camera system, there is included a signal processing circuit to which image information taken by the imaging device is input and which outputs image information signal-processed to the camera body.

In the camera system according to the invention, the image information outputted by the signal processing circuit can be displayed on a monitor and stored on the camera-body side.

It is preferable that, in the camera system, there is included an image memory capable of storing the image information processed by the signal processing circuit.

In the camera system according to the invention, the image information, stored on a frame-by-frame basis in the memory, can be read out and displayed on the display on the camera-body side.

It is preferable that, in the camera system, there is included a power source that supplies power to the drive circuit.

In the camera system according to the invention, the power, suited for supplying horizontal and vertical transfer pulse from the drive circuit to the imaging device, can be stably supplied by the own.

### BRIEF DESCRIPTION OF THE DRAWINGS

FIG. 1 is an overall perspective view showing a camera system according to the present invention;

FIG. 2 is a horizontal sectional view typically showing the state an imaging device unit is inserted in a camera body;

FIG. 3 is a figure showing a state of the imaging device unit inserted in the camera body, as viewed from an imaging-lens side;

FIG. 4 is an overall perspective view of a camera system as viewing the body case from a back-plate side; and

FIG. 5 is a block diagram showing an electric interfaces of between the imaging device unit and the camera body, in the invention.

### DETAILED DESCRIPTION OF THE INVENTION

An embodiment of the present invention will now be explained in detail based on the drawings.

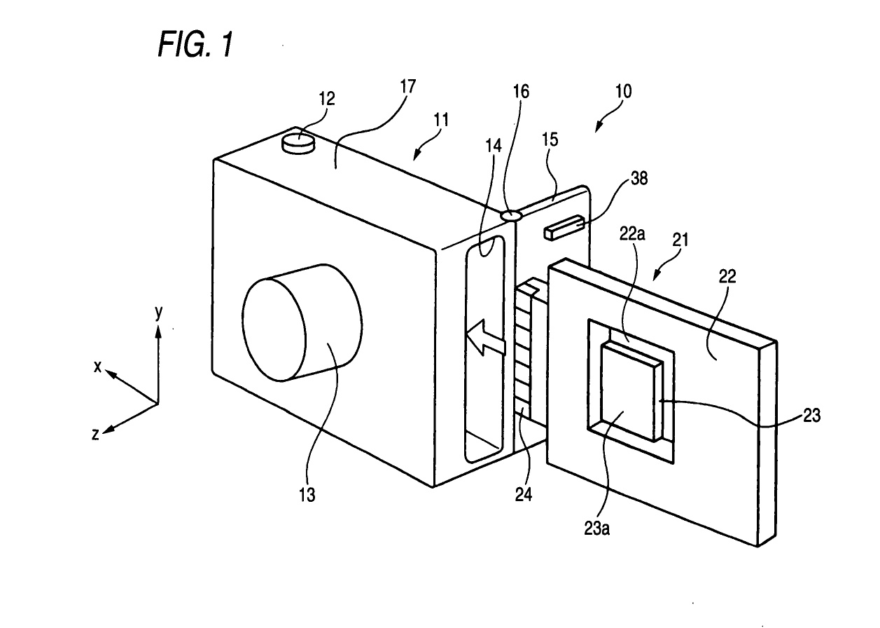

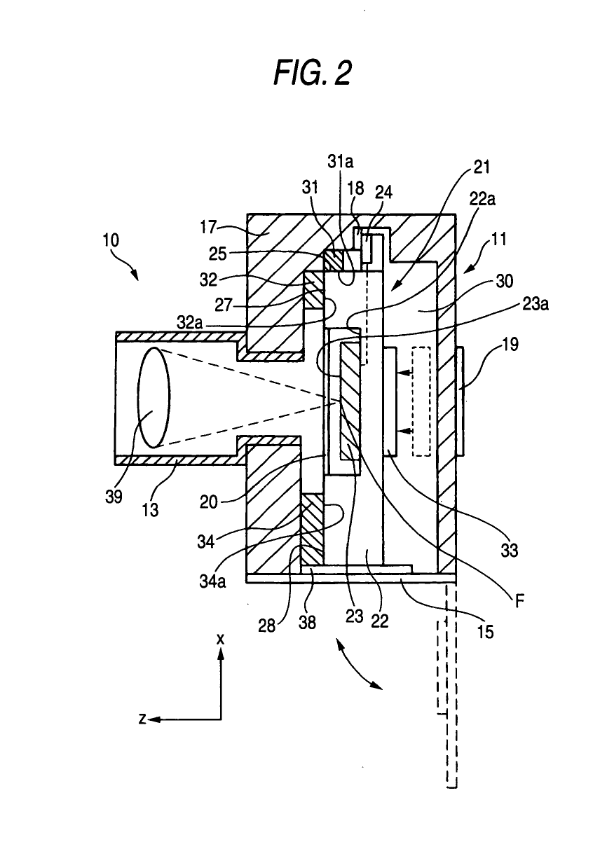

FIG. 1 is an overall perspective view illustrating a camera system according to the invention. FIG. 2 is a horizontal sectional view typically showing the state that an imaging device unit is received to a camera body.

A camera system 10 includes a camera body 11 and an imaging device unit 21 to be removably received in the camera body 11.

The camera body 11 has a body case 17 generally rectangular parallelepiped in form.

The body case 17 mounts thereon a lens barrel 13 that can be changed upon user's desire in accordance with a photographic subject. An objective lens 39 is fixed within the lens barrel 13. The objective lens 39 is to collect the luminous flux of image light from the subject and form a focus to which the luminous flux is collected to one point. Meanwhile, on the body case 17, there is provided an operating section 12, such as a shutter-release button, to be operated by the user's finger during taking a picture.

An insert-aperture 14 is formed in the body case 17 so that the imaging device unit 21 can be inserted in the body case 17 when attaching the imaging device unit 21. Meanwhile, a lid 15, for closing the insert-aperture 14, is arranged for opening and closing by means of a hinge 16. A biasing member 38 is provided on the inner surface of the lid 15 such that it abuts against part of an end surface of a board 22 in a closure state of the lid 15 and urges it in a direction the imaging device unit 21 is inserted (in FIG. 1 x-direction).

The imaging device unit 21 includes a board 22 formed as a plate member generally in a rectangular parallelepiped, a solid-state imaging device 23 fixed on the board 22, and a unit-end electrode terminal 24 electrically connected by a wiring line, not shown, to a drive circuit, not shown, for taking drive control of the solid-state imaging device 23.

The solid-state imaging device 23, in the invention, can use a CCD or a CMOS, for example. The solid-state imaging device 23 is fixed on a bottom of a recess 22a formed in one surface of the board 22 by means of an adhesive or the like such that its imaging surface 23a, for light reception, is exposed to the exterior of the imaging device unit 21. In the board 22, a transparent seal glass 20 is provided in a manner shielding the recess 22a, in order to prevent a foreign matter, such as a dust or dirt, from being put on the solid-state imaging device 23 fixed in the bottom of the recess 22a. Thus, the solid-state imaging device 23 is hermetically closed within the recess 22a.

As shown in FIG. 2, a receptacle 30 is provided in the camera body 11, to receive the imaging device unit 21 and hold it within the camera body 11. When attaching the imaging device unit 21 to the camera body 11, the imaging device unit 21 is inserted in the receptacle 30 in a state the solid-state imaging device 23, in the camera body 11, is positioned with its imaging surface 23a faced to the lens barrel 13. Meanwhile, in the state the imaging device unit 21 is received in the camera body 11, electric connection is provided by contacting the unit-end electrode terminal 24 of the board 22 with a body-end electrode terminal 18 formed inside the camera body 11.

In the camera body 11, a display section 19, such as an LCD, is formed in a back plate of the body case 17, on the side opposite to the lens barrel 13.

The imaging device unit 21 is held in the receptacle 30 of the camera body 11 such that the solid-state imaging device 23 fixed on the board 21 is positioned vertically intersecting at its imaging surface 23a with the optical axis of the objective lens 39. In this case, the imaging device unit 21 is held in an aligned state such that the imaging surface 23a of the solid-state imaging device 23 comes a position coincident with the focal point F of the objective lens 39.

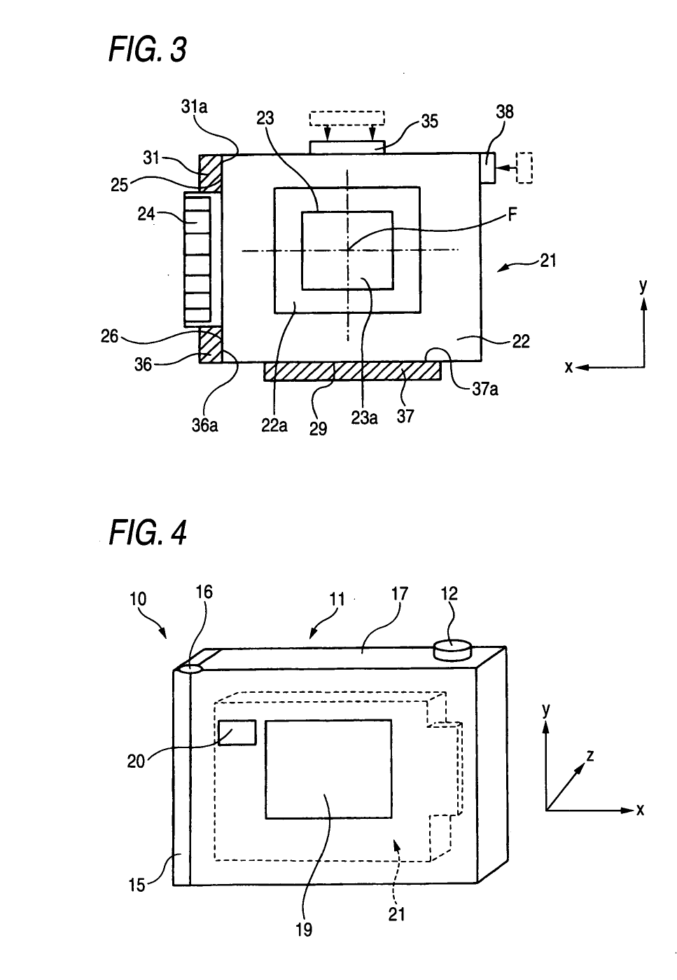

Explanation is now made on a structure that aligns the imaging device unit with the camera body 11. FIG. 3 shows a state that the imaging device unit 21 received in the camera body 11 is viewed from the objective lens 39 side.

In the receptacle 30 of the camera body 11, reference plates 31, 32, 34, 36, 37 are provided to abut against the imaging device unit 21 received and to align the imaging surface 23a of the solid-state imaging device 23 relatively with the objective lens 39.

In the state the imaging device unit 21 is attached, each of the reference plates 31, 32, 34, 36, 37 has a first reference plane perpendicular to the optical axis of the objective lens 39, a second reference plane formed vertical to the imaging surface 23a and a third reference plane formed vertical to the imaging surface 23a and to the second reference plane.

In this embodiment, the first reference plane refers to a surface 32a, 34a of the reference plate 32, 34 on the side closer to and in abutment against the board 22 of the imaging device unit 21 with respect to the direction the imaging surface 23a of the solid-state imaging device 23 opposes to the objective lens 39 (with respect to the arrow-z direction in FIG. 2).

The second reference plane refers to a surface 31a, 36a of the reference plate 31, 36 on the side closer to and in abutment against the board 22 of the imaging device unit 21 with respect to the direction the imaging device unit 21 is inserted into the receptacle 30 (with respect to the arrow-x direction in FIG. 3).

The third reference plane refers to a surface 37a of the reference plate 37 on the side closer to and in abutment against the board 22 of the imaging device unit 21 with respect to the direction vertical to the first and second reference planes (with respect to the arrow-y direction in FIG. 3).

Here, the board-side abutment surface 37a of the reference plate 37 may be taken as a second reference plane while the board-side abutment surface 31a, 36a of the reference plate 31, 36 may be taken as a third reference plane.

The imaging device unit 21 is provided with an abutment region at which abutted against the reference planes of the reference plates, in order to relatively align the imaging surface 23a with the objective lens 39.

The abutment region includes a first abutment region to abut against the first reference plane of the camera body 11, a second abutment region against the second reference plane and a third abutment region against the third reference plane.

In this embodiment, the first abutment-region refers to an abutment region 27, 28 of the board 22 on the side abutting against the first reference plane 32a, 34a with respect to the direction the imaging surface 23a of the solid-state imaging device 23 opposes to the objective lens 39 (with respect to the arrow-z direction in FIG. 2).

The second abutment region refers to an abutment region 25, 26 of the board 22 on the side abutting against the second reference plane 31a, 36a with respect to the direction the imaging device unit 21 is inserted into the receptacle 30 (with respect to the arrow-x direction in FIG. 3).

Furthermore, the third abutment region refers to an abutment region 29 of the board 22 on the side abutting against the third reference plane 37a with respect to the direction vertical to the first and second abutment regions (with respect to the arrow-y direction in FIG. 3).

In this embodiment, the abutment region of the board 22 of the imaging unit 21 is made in a flat surface on the board 22, relative to the reference plates 31, 32, 34, 36, 37 of the camera body 11. However, the abutment region may be a projection formed on the board 22. In case the abutment region is made as a projection, when the imaging device unit 21 is received in the camera body 11, the projection of the board 22 abuts against the reference plate 31, 32, 34, 36, 37. This makes it possible to hold the imaging device unit 21 in a state its imaging surface 23a is placed coincident with the focal point F of the objective lens 39. In this case, by forming the projection in a predetermined size, alignment is previously achieved such that the projection abuts against the reference plate 31, 32, 34, 36, 37 in a proper position. In this case, it is preferred that the focal point F positions at the center of the imaging surface 23a, as shown in FIG. 3.

Explanation is now made on a structure that holds the reference surfaces and the abutting regions in such a relative position as to provide an alignment of between the focal point of the objective lens 39 and the imaging surface 23a of the imaging device unit 11.

Biasing members 33, 35, 38 are provided interior of the body case 17. In the state the imaging unit 21 is received in the receptacle 30 inside the body case 17, the biasing members 33, 35, 38 urge the imaging unit 21 toward the reference plates 31, 32, 34, 36, 37 of the camera body 21, thus constituting an urge mechanism acting to push the imaging unit 21. The urge mechanism and the imaging device unit 21 received in the camera body 11 are kept in the state the abutment regions are placed in abutment against the reference plates 31, 32, 34, 36, 37 on the camera-body 11 side. In this manner, the imaging surface 23a of the imaging device unit 21 and the focal point of the camera body 11 are held in a proper position.

In this embodiment, the biasing member 33 is provided inside of the body case 17, to urge the first abutment region 27, 28 onto the first reference plane 32a, 34a.

The biasing member 38 is provided inside of the body case 17, to urge the second abutment region 25, 26 onto the second reference plane 31a, 36a.

The biasing member 35 is provided inside of the body case 17, to urge the third abutment region 29 onto the third reference plane 37a.

The biasing member 33, 35, 38 can use an elastic member such as a spring or of rubber. The biasing member 33, 35, 38 drives the imaging unit 21 forward and backward due to expansion and contraction thereof, for example. When the imaging device unit 21 is received, the biasing members 33, 35, 38 are abutted against and compressed by the board 22 of the imaging device unit 21 thereby providing a structure to urge the imaging device unit 21 onto the reference plates 31, 32, 34, 36, 37 of the camera body 11 due to an elastic repelling force.

Meanwhile, in order to prevent the imaging device unit 21 and the biasing member 33, 35, 38 from interfering with each other when attaching the imaging device unit 21, the biasing members 33, 35, 38 may be structurally moved to a retracted position. Meanwhile, when attaching the imaging device unit 21, the biasing members 33, 35, 38 may be structurally moved respectively in the FIG. 3 arrow directions associatively with the movement of the imaging device unit 21, into an abutment against the imaging device unit 21.

The urge mechanism is preferably the biasing member 33, 35, 38 that urges the imaging unit 21 onto at least one of the first reference plane 32a, 34a, the second reference plane 31a, 36a and the third reference plane 37a. In the state the imaging device unit 21 is urged onto the biasing members 33, 35, 38, the imaging device unit 21 at its abutment region is urged onto at least one of the reference surfaces 31a, 32a, 34a, 36a, 37a. While the imaging device unit 21 is being received in the camera body 11, the abutment region is placed in an abutment state against the reference plate 31, 32, 34, 36, 37 due to the urge force of the biasing members 33, 35, 38.

In the imaging device unit 21 according to the invention, when the imaging device unit 21 is received in the camera body 11, the abutment region formed on the imaging device unit 21 abuts against the reference plate 31, 32, 34, 36, 37 of the camera body 11, thereby holding the imaging device unit 21 in the state its imaging surface 23a is aligned with the focal point F of the imaging device lens 39. This makes it possible to properly align relatively between the focal point F of the objective lens 39 and the imaging surface 23a of the imaging device unit 21, at all times. Therefore, the imaging device unit 21 in the invention can prevent against the occurrence of shading and color noise, similarly to the solid-state imaging device of the existing camera system structured for previous reception in the camera body based on a predetermined design.

Meanwhile, in case using the imaging device unit 21 according to the invention, the imaging device unit 21 can be changed for a desired objective lens in accordance with use purpose without selecting the objective lens 39 suited for the characteristic of the solid-state imaging device 23.

Meanwhile, concerning the camera body 11 according to the invention, when the imaging device unit 21 is received in the camera body 11, the reference plates 31, 32, 34, 36, 37 provided in the camera body 11 regulate the position of the abutment regions of the imaging device unit 21. This makes it possible to hold the imaging surface 23a of the imaging device unit 21 in the aligned state with the focal point F of the objective lens 39. During taking an image, proper alignment is available at all times as to the relative position of the focal point F of the objective lens 39 and imaging surface 23a of the imaging device unit 21. Therefore, the camera body 11 in the invention can prevent against the occurrence of shading and color noise, similarly to the solid-state imaging device of the existing camera system structured for previous reception in the camera body due to a predetermined design.

FIG. 4 is an overall perspective view of the camera system as viewed the body case from the back-plate side. As shown in FIG. 4, a window 20 may be provided in the back plate of the body case 17. The window 20 may be provided by structuring part of the back plate of a transparent resin or the like. In the state the imaging device unit 21 is received in the camera unit 11, the imaging device unit 21 received in the receptacle 30 is partly exposed to the exterior of the body case 17 through the window 20. Due to this, the user is allowed to visually recognize the presence or absence of the imaging device unit 21 through the window 20. When confirming the imaging device unit 21, there is no need to open the lid 15 of the body case 17.

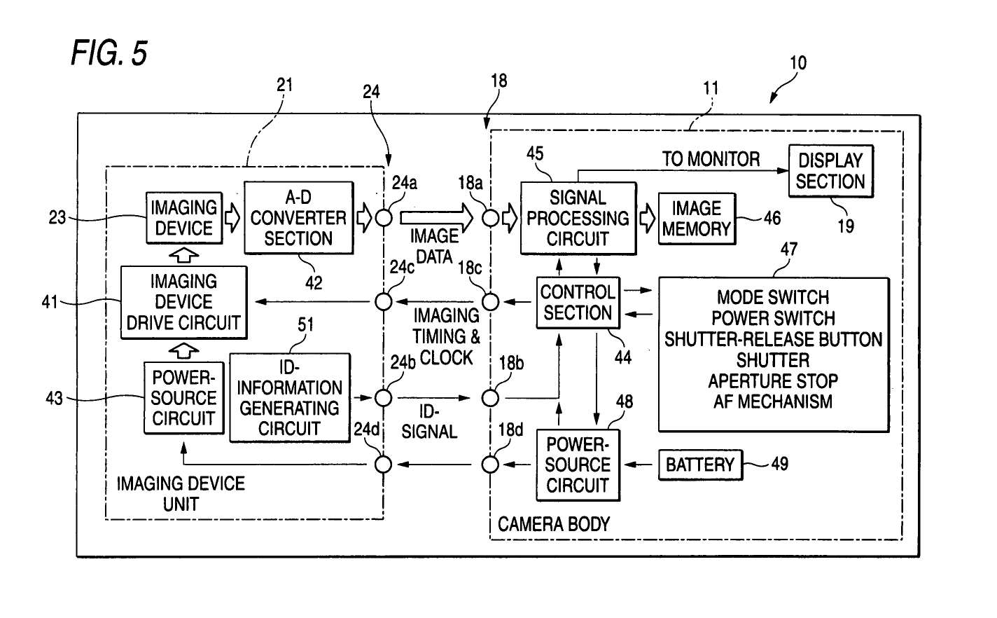

FIG. 5 is a block diagram showing an electric interface of between the imaging device unit 21 and the camera body 11, in the camera system, wherein like reference numerals are attached to the same structural elements as those shown in FIGS. 1 to 4.

The imaging unit 21 includes a solid-state imaging device 23, an imaging device drive circuit 41, an A-D converter section 42, a power source circuit 43 and an ID-information (identification information) generating circuit 51.

Of these, the solid-state imaging device 23 serves to receive the optical image of a subject, taken through the objective lens 39, through a focus lens or a restriction, followed by photoelectrical conversion (change into electric charge) thereof. This is constituted by an lattice arrangement of photoelectric converters, e.g. CCD elements.

The imaging device drive circuit 41, immediately before taking an image, serves to sweep the unwanted charge (dark current) out of the solid-state imaging device 23 by use of an imaging-start timing signal, as a trigger, of from the camera body 11.

Receiving a sweep-complete signal outputted from the control section 44, the imaging device drive circuit 41 serves to output a transfer pulse to the solid-state imaging device 23 depending upon a clock signal outputted from the camera body 11.

Receiving the transfer pulse, the A-D converter section 42 serves to digitalize the analog image signal outputted from the solid-state imaging device 23 and output it to a signal-processing circuit 45, referred later, on the camera-body 11 side.

The power-source circuit 43 regulates the power received from the battery 49 on the camera-body 11 side into a setting level and supplies it to the imaging device drive circuit 41 and the like, thus placing it in operable.

The ID-information generating circuit 51 serves to generate ID information for identifying a solid-state imaging device 23 (and/or imaging device unit 21). The ID information includes information about the sensitivity of the imaging device and information identifying the type of the solid-state image, i.e. whether it is for taking an infrared-ray image, a color image, a black-and-white image, a ultraviolet-ray or the like.

Meanwhile, the camera body 11 includes a signal-processing circuit 45, an image memory 46, the foregoing display 19, a control section 44, an input section (operating section) 47 for various pieces of information, a power-source circuit 48 and a battery 49.

Of these, the signal-processing circuit 45 serves to convert the digital-image signal of a subject obtained from the imaging device unit 21 into an image signal containing a luminance signal, a chrominance or color signal, etc. It also serves to perform an encoding of the image signal, as required, in order for compression and execute a processing to reduce the amount of data.

The image memory 46 serves to store a frame-based image signal compressed by the signal-processing circuit 54.

The display section 19 is provided at the back surface of the camera body 11, which serves to read out the information stored in the image memory 46 and display it on the screen.

The control section 44 serves to output an imaging-start timing signal for sweeping the unwanted charge out of the solid-state imaging device 23 immediately prior to taking an image, e.g. upon setting up the aperture stop, and a clock signal for transferring data from the solid-state imaging device 23, to the imaging device drive circuit 41.

The input section 47 serves to input switch and operation-instruct signals, for selecting a camera operation mode, of from a mode switch, a power switch, a shutter-release button, a shutter, an aperture stop and an auto-focus mechanism to the control section 44.

The power-source circuit 48 serves to regulate the voltage of from the battery 49, as a power source, to a constant voltage and current having a setting level and supply it to camera-body 11 various sections including the control section 44 and to the imaging device unit 21.

Meanwhile, the imaging device unit 21 is provided with unit-end electrode terminals 24a, 24b to output the digital image data and the ID signal toward the camera body 11 as well as unit-end electrode terminals 24c, 24d to supply the imaging-start timing signal, the clock signal and power from the camera-body 11 side.

On the other hand, the camera body 11 is provided with body-end electrode terminals 18a, 18b to input the digital image data and the ID signal from the imaging device unit 21 as well as body-end electrode terminals 18c, 18d to output the imaging-start timing signal, the clock signal and power to the imaging device unit 21. The body-end electrode terminals 18a, 18b, 18c, 18d serve as an interface.

Explanation is now made on the operation.

At first, concerning the imaging device unit 21 and the camera body 11 that respectively have the electric interfaces, the imaging device unit 21 is attached to the camera body 11 as shown in FIG. 2. This provides an electric connection between the unit-end electrode terminals 24a-24d and the body-end electrode terminals 18a-18d that respectively structure the interfaces.

Consequently, electric-signal exchange is available at between the imaging device unit 21 and the camera body 11.

The user presses the power switch in the input section 47 of the camera body 11. This places the power-source circuit 48 into operation. The voltage of from the battery 49 is regulated to a predetermined voltage value by the power-source circuit 48 and supplied to the various sections of the camera body 11. The voltage is supplied also to the imaging device drive circuit 41 through the interfaces 18, 24 and the power circuit 43 of the imaging device unit 21. Meanwhile, the shutter-release button, the aperture stop, etc. become usable while the AF mechanism becomes operative.

Meanwhile, the ID information (identification information) unique to the imaging device unit 21 is inputted from the ID-information generating circuit 51 of the imaging device unit 21 to the control section 44 of the camera body 11 through the terminals 24b, 18b of the interfaces. The control section 44 receives the ID information and identifies the type of the imaging device unit 21, thus setting a parameter for the signal-processing circuit. The ID information has pieces of information about solid-state imaging device sensitivity, color/black-and-white image, infrared-ray image, ultraviolet-ray image, low/high pixels, other imaging device characteristics, contamination degree and so on.

Here, setting is made as to lens opening and zooming on the input section 47, and the photographic scene is fixed while viewing the subject image being displayed on the display section 19, to press the shutter-release button.

The setting information at this time is conveyed as a imaging-start timing signal from the control section 44 to the imaging device drive circuit 41 of the imaging device unit 21. The imaging device drive circuit 41 sweeps a dark current out of the solid-state imaging device 23 at immediately before taking an image. This places the solid-state imaging device 23 active in taking an image.

Subsequently, when the shutter is opened and closed, the optical image of a subject is captured to the imaging surface 23a of the solid-state imaging device 23 through the objective lens 13. Note that the electronic shutter for the solid-state image 23 may be turned on/off in synchronism with the shutter button operation on the camera body 11.

The imaging device drive circuit 41 receives a clock signal from the control section 44 and outputs a transfer pulse, for transferring data, to the imaging device 23. Receiving the transfer pulse, an analog image signal that the optical image has been converted into a charge amount is read out of the solid-state imaging device 23 and outputted to the A-D converter section 42.

The A-D converter section 42 converts the analog image signal into a digital image signal and supplies it to the signal-processing circuit 45 on the camera-body 11 side.

The signal-processing circuit 45 writes the input digital image data on a frame-by-frame basis to the image memory 46. When the display section 19 is used as a viewfinder, the image memory 46 temporarily records the image data as low-resolution image data processed by the signal-processing circuit 45.

Meanwhile, the image data recorded in the image memory 46 is read out by the signal-processing circuit 45 and displayed on the display section 19.

As described above, where the imaging device unit 21 has been changed for the camera body 11, it is easy to take the optimal image in accordance with the imaging device-unit-based functional update, e.g. in imaging device sensitivity, color image, black-and-white image and ultraviolet-ray image, while preventing against shading and color noise as described before.

Although the embodiment explained the case where the signal-processing circuit 45 is provided on the camera-body 11 side, it may be provided on the imaging device-unit 21 side.

In such a case, the image data, compatible with the ID information due to the attached imaging device unit 21, can be processed at the imaging device-unit 21 end without intervening the interfaces. This improves the accuracy of signal processing, thus making it possible to supply quality image data to the image memory 46 and display section 19 of the camera body 11.

Meanwhile, although the embodiment explained the case the image memory 46 is provided on the camera-body 11 side, it may be provided on the imaging device-unit 21 side.

In such a case, the image data processed at the signal-processing circuit 45 can be stored on the imaging device-unit 21 side. Accordingly, by carrying the imaging device unit 21, it can be attached to another camera body of the same type where the imaging device unit 21 can be changed. Thus, the image on the image memory 46 can be viewed on the display section of the other camera body. In addition, the camera body 11 can be simplified in its internal arrangement.

Meanwhile, although the embodiment explained the case the battery 49 is provided on the camera-body 11 side, it may be on the imaging device-unit 21 side.

In such a case, a power-source battery can be changed simultaneously or concurrently during the exchange operation of the imaging device unit for the camera body 11. In this case, the power-source switch is desirably provided on the camera-body 11 side.

Furthermore, according to the embodiment, where the imaging device unit 21 is changeable for the camera body 11 having a desired imaging-lens characteristic, the setting of parameters, camera sensitivity, etc. is performed automatically for the signal-processing circuit 45.

According to the present invention, in a camera system having a camera body and an imaging device unit to be removably attached to the camera body, it is possible to provide an imaging device unit and a camera system having the imaging device unit that can supply the identification information about the solid-state imaging device to the camera-body side.

The present invention has the effect that the identification information of the solid-state imaging device is to be supplied to the camera-body side, hence being useful for the imaging device unit to be easily removaly inserted in a camera body and a camera system, etc.

The entire disclosure of each and every foreign patent application from which the benefit of foreign priority has been claimed in the present application is incorporated herein by reference, as if fully set forth.

What is claimed is:

1. An imaging device unit to be removably attached to a camera body having an objective lens, the imaging device unit comprising:
a board;
a solid-state imaging device fixed on the board;
a drive circuit that drives the solid-state imaging device;
an identification-information generating circuit that generates identification information to specify the solid-state imaging device; and
an interface electrically that is connected to the camera body in a state attached to the camera body and supplies identification information to the camera body.

2. An imaging device unit according to claim 1,
wherein an imaging-timing signal, inputted from the camera body, is outputted to the drive circuit through the interface.

3. An imaging device unit according to claim 1,
wherein image information taken by the imaging device is outputted toward the camera body through the interface.

4. An imaging device unit according to claim 1,
wherein a clock signal, inputted from the camera body, is outputted to the drive circuit through the interface.

5. An imaging device unit according to claim 1, further comprising a power-source circuit that receives power from a power source provided in the camera body and supplies power to the drive circuit.

6. A camera system comprising:
an imaging device unit according to claim 1; and
the camera body.

7. A camera system according to claim 6, further comprising
a signal processing circuit to which image information taken by the imaging device is input and which outputs image information signal-processed to the camera body.

8. A camera system according to claim 6, further comprising
an image memory capable of storing the image information processed by the signal processing circuit.

9. A camera system according to claim 6, further comprising
a power source that supplies power to the drive circuit.
